(19) United States
(12) Patent Application Publication
(10) Pub. No.: US 2026/0309610 A1
(43) Pub. Date: Oct. 8, 2026

(54) PARTICLE CHARACTERIZATION SYSTEM

(71) Applicant: UNIVERSITE DE GENEVE, Geneva 4 (CH)

(72) Inventors: Takuji ADACHI, Geneva (CH); Oscar URQUIDI GANDARILLAS, Geneva (CH)

(21) Appl. No.: 19/484,725

(22) PCT Filed: Apr. 15, 2024
(86) PCT No.: PCT/EP2024/063145

§ 371 Date: Nov. 14, 2025

(30) Foreign Application Priority Data
May 17, 2023 (EP) 23173928.5

(51) Int. Cl. G01N 15/0205; G01N 15/00

(52) U.S. Cl. CPC G01N 15/0211; G01N 2015/0053; G01N 2015/0222

(57) ABSTRACT

A particle characterization system (2) for measuring at least the size of particles (17) in a liquid or colloidal medium (15), comprising an optical system (3), an optoelectronic detection system (5), and a computing system (6), the optical system (3) comprising an illumination system (8) configured to generate a light beam to illuminate the particles (17), a microscope objective (10) configured to guide the light beam to the particles (17) and collect the scattered light from the particles, a light focusing device (12) configured to focus the scattered light from the sample to the optoelectronic detection system (5), the optoelectronic detection system (5) comprising a photon detector (22) and a data acquisition module (24) connected to the photon detector (22), the optoelectronic detection system configured to time tag photons detected by the photon detector (22) and to transmit the time tagged photon data to the computing system (6), the computing system (6) comprising post-processing software configured to compute particle size distributions using an auto-correlation or cross-correlation computation on a bin group retained in a time window of a selected duration.

The present invention relates to a system for characterization of nano to sub-micron size particles, in particular including to locally measure the size distribution of particles in colloidal suspensions.

Dynamic light scattering (DLS) is a known technique used for the non-destructive size characterization of sub-micron and nano-objects in solution. It is based on the correlation of time dependent light intensity fluctuations of interfering wavefronts, originated by scattered light at individual colloidal particles undergoing Brownian motion. The diffusion coefficient of the particles in solution can be obtained from the decay of a correlation function, which can be converted to its size.

It is further known to use Raman spectroscopy to probe chemical structural features of particles.

Conventional systems for measuring the size of particles in colloidal suspensions are intended for the measurement of particle sizes that are substantially static or slowly changing.

There are however applications in which the measurement of the evolution of particle sizes that are rapidly evolving would be very useful. Current systems are either not capable of measuring rapid particle size evolution, or if implemented for measuring rapid particle size evolution would be too inaccurate or unreliable due to a low signal to noise ratio or to artefacts.

In view of the foregoing, it is an object of this invention to provide a system for tracking the evolution of the size of particles in a liquid or in colloidal suspensions, that is accurate, reliable and rapid, in particular that is able to measure particle size evolution at high time resolutions, for instance as short as Ims (one millisecond).

It is advantageous to provide a system for simultaneously tracking the evolution of particle size as well as the chemical properties (chemical composition, solid state structure such as crystallinity, crystal polymorphs, and the like) of particles in a liquid or in colloidal suspensions at high time resolutions that is accurate, reliable and rapid.

It is advantageous to provide a system for tracking the evolution of the size of particles in a liquid or in colloidal suspensions, optionally with simultaneous measurement of chemical properties of the particles, that is economical, in particular that is economical to install and to operate.

Objects of this invention have been achieved by providing a system and a method according to the independent claims. Dependent claims set forth various advantageous features of embodiments of the invention.

Disclosed herein is a particle characterization system for measuring at least the size of particles in a liquid or colloidal medium, comprising an optical system, an optoelectronic detection system, and a computing system, the optical system comprising an illumination system configured to generate a light beam to illuminate the particles, a microscope objective configured to guide the light beam to the particles and collect the scattered light from the particles, a light focusing device configured to focus the scattered light from the sample to the optoelectronic detection system, the optoelectronic detection system comprising a photon detector and a data acquisition module connected to the photon detector, the optoelectronic detection system configured to time tag photons detected by the photon detector and to transmit the time tagged photon data to the computing system.

Time-tagged single photon arrival times are arranged in bins, a plurality of said bins forming a bin group.

According to a first aspect of the invention, the computing system comprises post-processing software configured to compute particle size distributions using an auto-correlation or cross-correlation computation on a bin group retained in a time window of a selected duration, wherein the post-processing software is further configured to perform a plurality of particle size distribution computations based on different time windows of different durations.

According to a second aspect of the invention, the computing system comprises post-processing software configured to compute particle size distributions using an auto-correlation or cross-correlation computation on a bin group retained in a time window of a selected duration, wherein the post-processing software of the computing system comprises a correlation lag time binning module configured to generate bins of successively increasing durations to form at least one said bin group.

In an advantageous embodiment, the illumination system comprises a laser device configured to generate a laser beam for illumination of the particles.

In an advantageous embodiment, the particle characterization system further comprises a bandpass filter arranged in the illumination path configured to filter the wavelength of scattered light received from the sample configured to allow light wavelength of the laser to pass therethrough to the optoelectronic detection system.

In an advantageous embodiment, the particle characterization system further comprises a spectroscopy system including a spectroscopy excitation device configured to generate a spectroscopy excitation beam projected through the microscope objective to the particles of the sample, and a spectroscopy detection device configured to receive the spectroscopy excitation beam returned from the particles back through the microscope objective and the light focusing device.

In an advantageous embodiment, the spectroscopy system comprises a first dichroic mirror for reflecting the spectroscopy excitation beam through the microscope objective, and a second dichroic mirror for reflecting the return beam to the spectroscopy detection device.

In an advantageous embodiment, the spectroscopy excitation device and spectroscopy detection device are configured for Raman spectroscopy.

In an advantageous embodiment, the optoelectronic detection system comprises at least a second photon detector receiving the returned particle scattered light via a beam splitter.

In an advantageous embodiment, the bins have a duration of a constant A plus a variable W (A+W), the successive bin durations having a duration corresponding to the constant A plus an integer multiple n of the variable W (A+nW).

In an advantageous embodiment, the correlation lag time binning module is configured to generate a plurality of bin groups (G, G1, . . . Gi), whereby the bin durations of different bin groups (G, G1, . . . Gi) have different variables W, W1, . . . Wi.

In an advantageous embodiment, the optical system is configured to direct the light beam generated by the illumination system at an oblique angle β through the sample system relative to an optical centre axis of the microscope objective.

In an advantageous embodiment, the oblique angle β is in a range of 1° to 45°, preferably in a range of 3° to 35°, more preferably in a range of 5° to 30°.

The present invention advantageously allows to locally measure the size distribution of particles (nano to sub-micron size) in colloidal suspensions at high time resolutions, allowing to follow dynamic processes in which particle size changes over time.

Embodiments of the invention also allows one to combine multiple short time acquisition windows to obtain sub-ensemble measurements and build statistics from the ensemble particle size distribution of the sample. Finally, the dynamic light scattering using an optical microscope configuration, allows the additional coupling of spectroscopic tools to probe chemical structural features, while measuring the particle size evolution.

Further objects and advantageous features of the invention will be apparent from the claims, from the detailed description, and annexed drawings, in which:

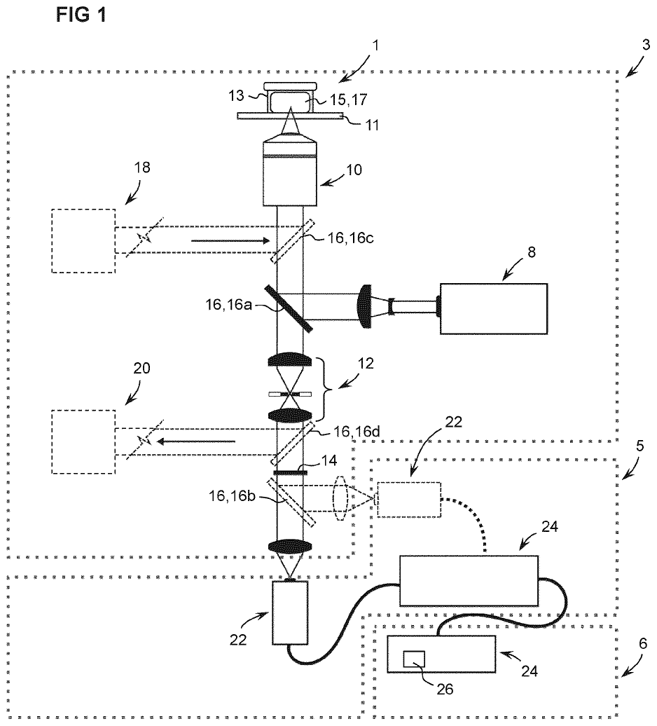

FIG. 1 is a schematic illustration of a system according to an embodiment of the invention;

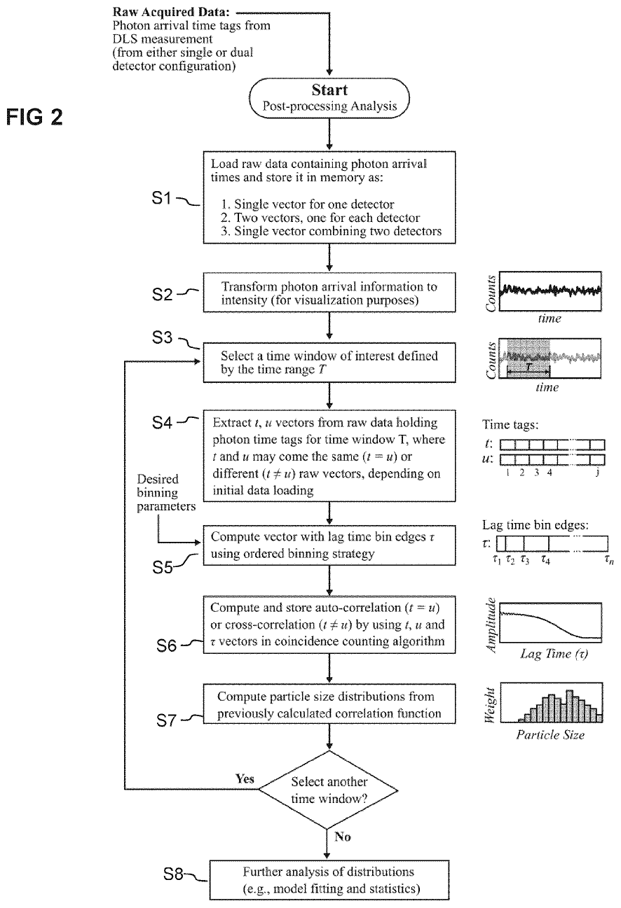

FIG. 2 is a flow chart showing the main stages of the analysis process according to an embodiment of the invention;

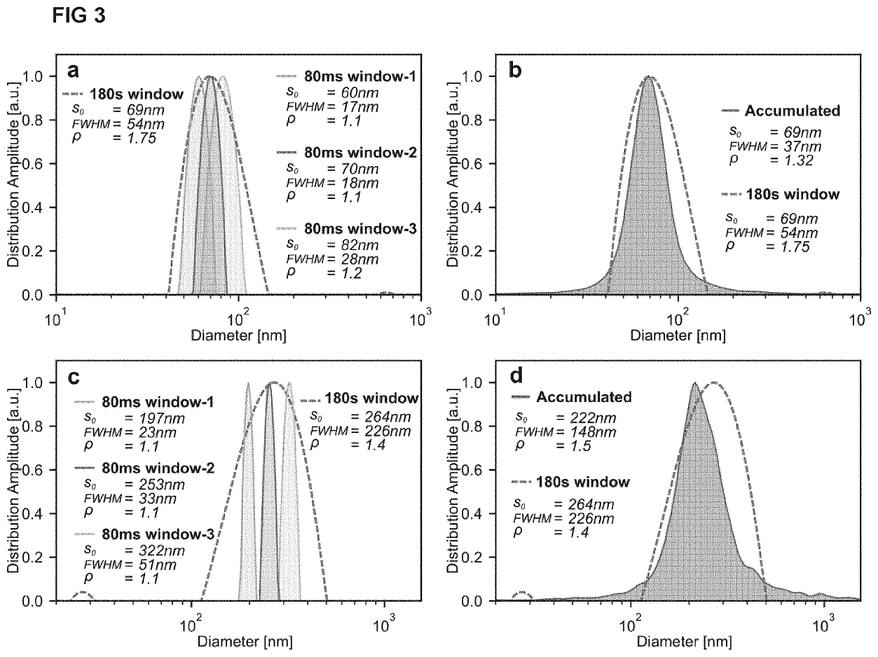

FIG. 3 illustrate normalized plots of particle size versus distribution amplitude, showing a comparison of normalized size distributions for a sample containing (a, b) 60 nm (0.1 wt %) and (c, d) 220 nm (5 wt %) polystyrene particles, whereby panels a-c show three examples of size distributions obtained from single 80 ms time windows, compared to the size distribution from a single 180 s time window, for 60 nm and 220 nm samples respectively and panels b-d show the accumulation of several consecutive 80 ms time windows over a 180 s time span, compared to the size distribution from a single 180 s time window, for 60 nm and 220 nm samples respectively;

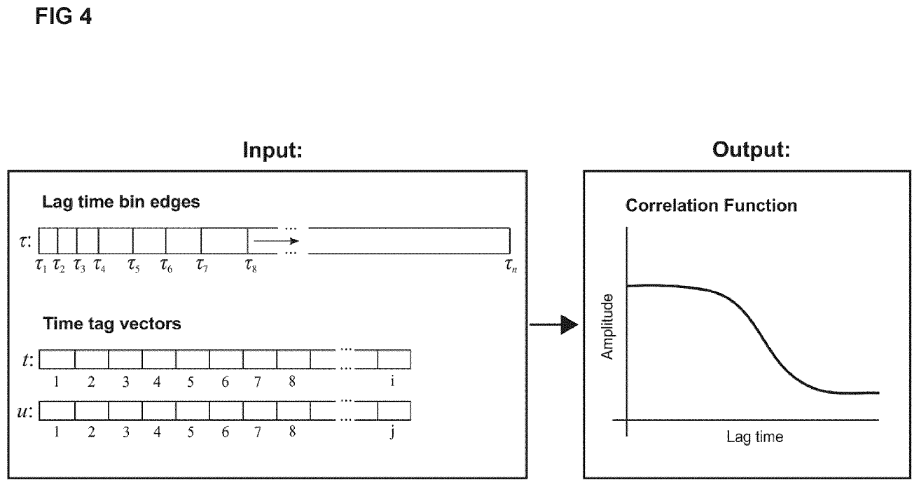

FIG. 4 illustrates a graphic description of the input and output of a coincidence counting algorithm according to an embodiment of the invention, whereby three vectors are input: the bin edges τ, as well as t and u containing the photon arrival time tags, and the output is the correlation function for each bin;

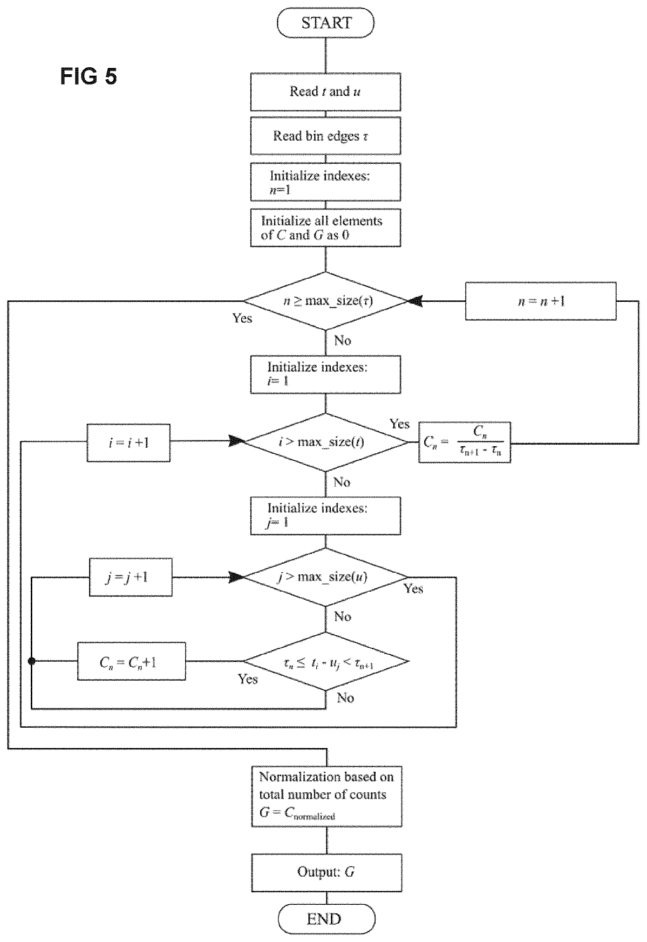

FIG. 5 illustrates a flow chart describing a coincidence counting algorithm used to calculate the correlation function at discrete lag times according to an embodiment of the invention;

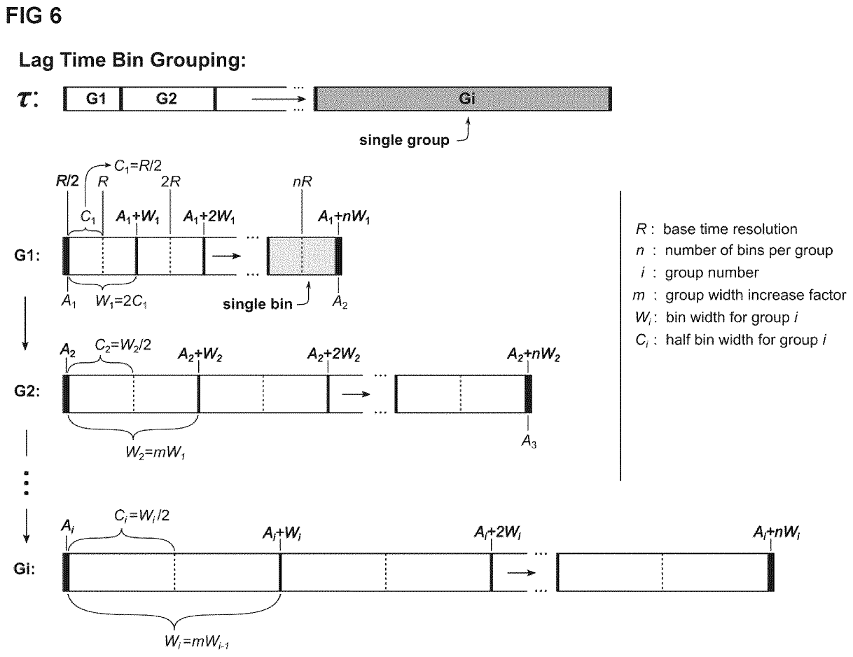

FIG. 6 illustrates a graphic representation of the binning strategy used to calculate the bin margins for a coincidence counting algorithm, and later used to calculate the correlation curve of photon arrival events, according to an embodiment of the invention;

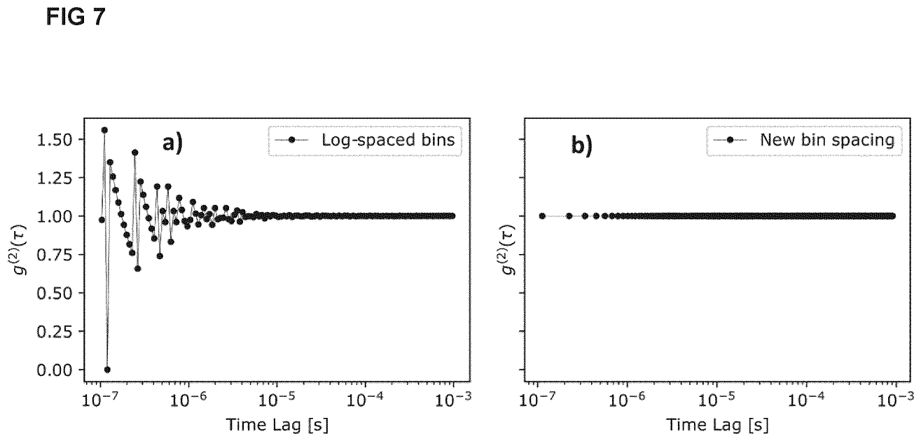

FIG. 7 illustrates a simulation of the auto-correlation of a perfect stream of photons by using a) a log-spaced bin distribution and b) a binning strategy according to an embodiment of the invention;

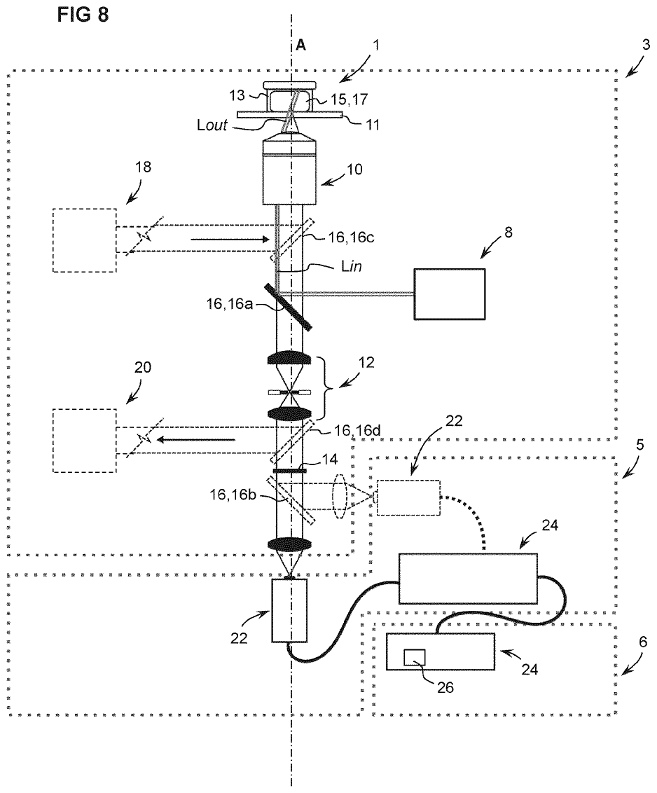

FIG. 8 is a schematic illustration of a variant of the system of FIG. 1, with oblique illumination, according to an embodiment of the invention;

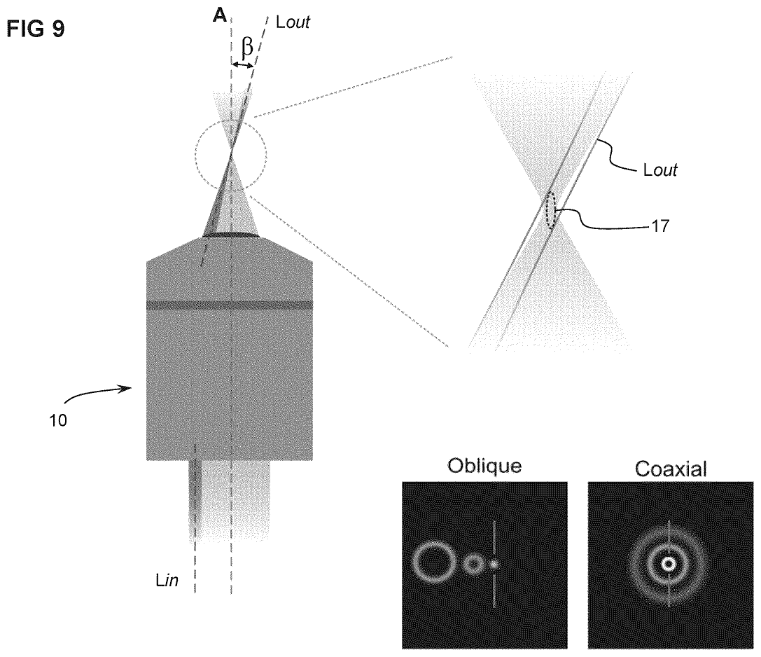

FIG. 9 is a detail schematic view of an objective and illumination beam of the variant of FIG. 8;

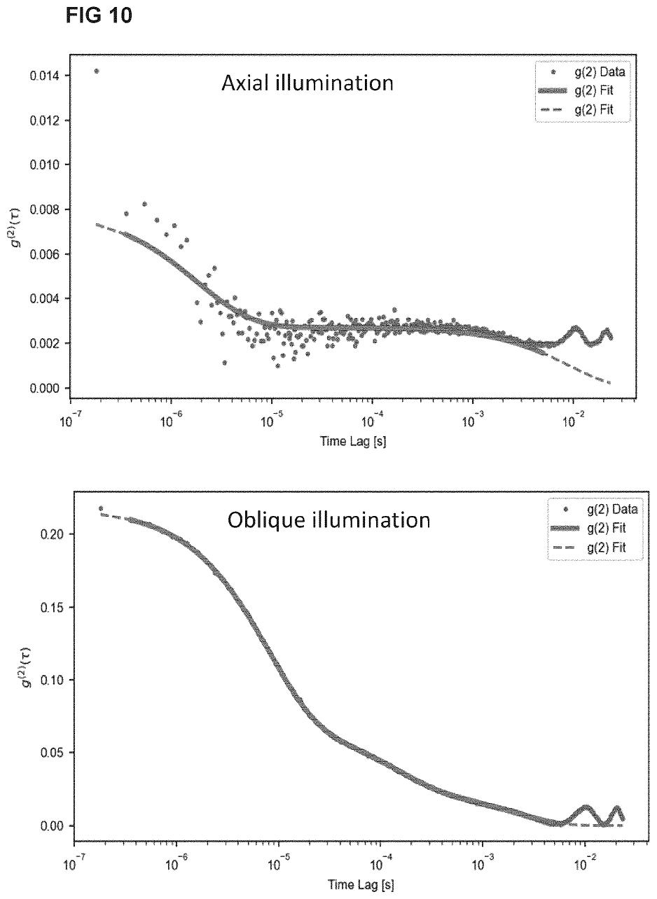

FIG. 10 are plots of amplitude of autocorrelation as a function of photon time lag for axial illumination and for oblique illumination,

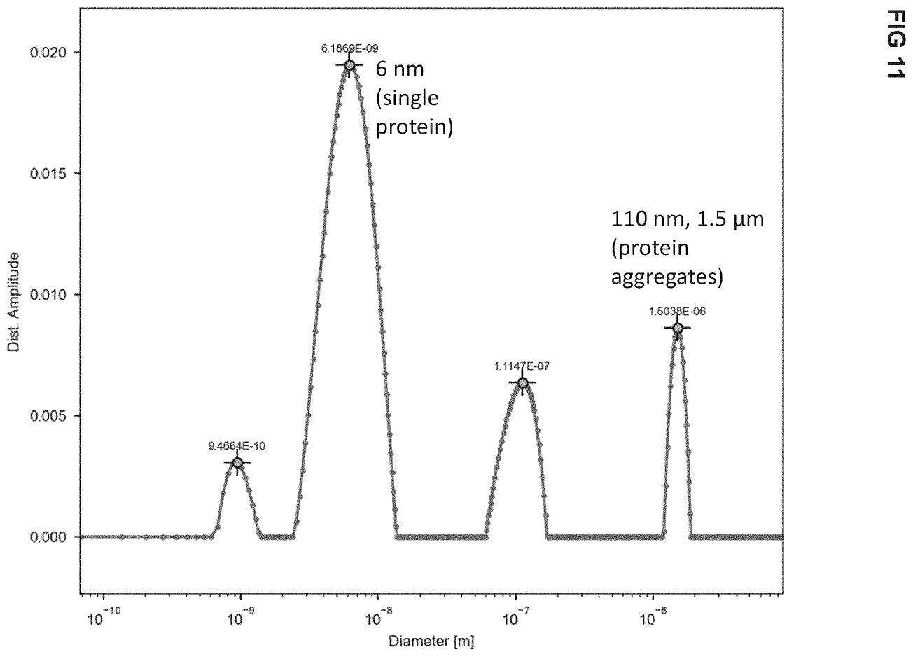

FIG. 11 is a plot of particle size versus distribution amplitude for oblique illumination.

Referring to the figures, starting in particular with FIG. 1, a particle characterization system 2 according to an embodiment of the invention is schematically illustrated. The particle characterization system 2 comprises an optical system 3, an optoelectronic detection system 5 and a computing system 6. In a preferred embodiment, the particle characterization system 2 may further comprise a spectroscopy system 4 directly integrated and connected to the optical system 3. The particles 17 to be characterized are in a medium 15, either as particles in suspension in a liquid or in a form of a colloidal suspension 15, 17, contained within a sample container 13 that is mounted on a sample stage 11, the sample stage 11 forming part of the optical system 3. The sample system 1 thus functionally comprises the sample stage 11, sample container 13, and sample 15, 17 formed of the liquid colloidal medium 15 and the particles 17 suspended in the medium 15.

The optical system 3 comprises an illumination system 8, a microscope objective 10, a light focusing device 12, and at least one dichroic mirror/beam splitter 16, 16a, 16b configured to direct the light generated by the illumination system 8 towards the sample system 1. The illumination system may in particular comprise a laser. The light beam generated by the illumination system passes through the microscope objective 10 to impinge upon the sample, and is scattered by the particles 17. The scattered light photons from the sample particles (the sample beam) passing back through the microscope objective 10 are captured by the optoelectronic detection system 5.

The optical system 3 further comprises a light focusing device 12, for instance comprising a tube lens 12a, pinhole 12b, and relay lens 12c, that is configured to focus the light returning from the sample system 1, namely the photons scattered by the particles 17 in suspension upon illumination from the laser 8, received by the optoelectronic detection system. The light focusing device 12 thus serves to focus the returned sample beam to the optoelectronic detection system 5.

The optoelectronic detection system 5 comprises at least one photon detector 22 and a data acquisition module 24 connected to the photon detector 22. The data acquisition module 24 is further connected to the computing system 6 and serves as a pre-processing station for acquisition of the photon information captured by the photon detector 22, for transmission and further processing in the computing system 6.

The optical system 3 may further comprise a bandpass filter 14 arranged between the microscope objective 10 and the photon detector 22 configured to filter out light with wavelengths that are out of the range of the wavelengths of light scattered by the particles 17 upon illumination from the laser beam. For instance if the laser beam has a wavelength of 532 nanometers, the bandpass filter be configured to allow light wavelength in a small window (e.g. 530 to 534 nm) around the 532 nanometers wavelength.

In an embodiment, the optoelectronic detection system 5 may comprise a second photon detector receiving photons from a beam splitter 16b that also allows photons to pass through the beam splitter to the first photon detector 22a. The second detector is optional and can increase the number of photons that can be counted and the signal to noise ratio improves, and therefore overall time resolution is better with two detectors. Two detectors may also be used in a measurement requiring the calculation of a cross-correlation, for instance used to extract rotational diffusion of anisotropic shaped particles.

According to an advantageous aspect of the invention, because the particle characterization system of the present invention comprises an optical system 3 for illuminating the sample with a collimated beam and collecting the scattered light through a microscope objective, the same optical arrangement may be used to integrate a spectroscopy system 4.

The spectroscopy system may also use the optical path through the microscope objective and through the focusing device 12.

A spectroscopic excitation beam may pass through the microscope objective to the sample 15, 17 and the reflected/diffused light returned through the microscope objective and light focusing device 12 for collection by the spectroscopy detector such that a chemical analysis, for instance using Raman spectroscopy, may be performed on the particles 17.

The spectroscopy system 4 comprises a spectroscopy excitation device 18, and a spectroscopy detection device 20. The spectroscopy system 4 may comprise at least first and second dichroic mirrors 16c, 16d, the first dichroic mirror for receiving and reflecting the spectroscopy excitation beam transmitted by the spectroscopy excitation device 18 towards the sample system 1, passing through the microscope objective 10, and allowing the returned spectroscopy beam to pass through the microscope objective and the light focusing device, and subsequently reflected off the second dichroic mirror 16d towards the spectroscopy detection device 20.

Thus, advantageously, the integration of a dynamic light scattering measurement system in an optical set up as described above, further allows easy and direct integration of a spectroscopy system 4 for measurement of the chemical structure and properties of the observed particles 17 simultaneously with the particle size characterization.

The computing system 6 comprises post processing software configured to compute particle size distributions, and to compute additional analysis of particle size distributions, from the time tagged photon data received from the data acquisition module 24 of the optoelectronic detection system 5.

According to an aspect of the invention, the post-processing software includes a correlation lag time binning module 26 configured to arrange the bins that will be later used to compute the correlation by sorting the time tagged photon measurements in bin groups with different time delay values.

As illustrated in FIG. 6, the different time delay values may for instance comprise bins with successively increasing bin sizes. The bin size may for instance increase by integer factor values of the preceding bin size, for instance if the first bin size comprises a value of A1+W1, subsequent bin size values may comprise sizes of A1+(n×W1), n being an integer that increases by the count of 1 or that could potentially increase with a count of 2 or 3 or more.

Different bin groups may be formed with time values A and W that are different and each individual time tagged photon may thus be found in a plurality of bin groups G, but at the most in only one bin in any particular bin group. As described further on, one of the advantages of arranging the time tag photon measurements in time resolved bin groups G that are not arbitrary but based on an ordered sequence of bin groups of increasing time-based size, reduces artefacts and noise, especially for very small particles and for rapidly revolving particle size evolution. Thus, the quality of particle size characterization with auto correlation or cross-correlation computed on the values in the ordered time resolved bins is improved compared to arbitrary sized bins. As the recording of photon arrival times is a discrete process with a defined maximum reference acquisition frequency, the use of an arbitrary binning strategy generates a so-called aliasing or moiré effect, as a result of an uneven resampling of photon arrival times in arbitrary time bins. The ordered time tagged binning according to this invention removes this undesirable effect by using the acquisition frequency as a reference to construct the bins.

According to another aspect of the invention, particle size characterization may be performed by computing and storing auto-correlation of time tagged photons over a short time window, for instance between 10 milliseconds and 100 milliseconds, preferably between 20 milliseconds and 80 milliseconds, and to perform the particle size characterization for different length time windows. This aspect allows to observe the rapid evolution of particle sizes, which differentiates over conventional systems that calculate the correlation function with an arbitrary lag time binning, from single (larger) time windows that only allow to characterize particle size distribution for an essentially static or slowly evolving particle size situation.

In other words, according to an aspect of the invention a plurality of time windows of different time lengths are used for the computation of particle size distributions by auto-correlation algorithms in order to analyse the evolution of the particle size in real time. This would allow for instance not only the analysis of particle size growth or reduction in any given process, but also to intervene in the process for instance by chemical, optical, mechanical (pressure) and other process steps to regulate the particle size evolution. Such analysis may be used in various fields for not only understanding particle forming or dissolving processes, but also to define or control process parameters to obtain particles of particular specific sizes. For example, in the pharmaceutical industry, polymorphs of an active pharmaceutical ingredient is a key parameter that affects the efficacy of drugs. The polymorph can convert from one to another during the formulation and during the size growth, and therefore it is advantageous to monitor size and polymorphism simultaneously in a convenient method such as DLS (dynamic light scattering).

In summary, the particle characterization system according to embodiments of the invention falls into the technological category of DLS (dynamic light scattering) and brings new functionalities for the time-resolved measurement of particle size distributions. The optical system is based on an optical microscope in which coherent light is focused on a colloidal sample through a microscope objective and then the light scattered by the sample is collected by the same objective, filtered by a band pass filter, and delivered to at least one light detector (there can be more than one), for instance in a confocal configuration. Multiple optical components including lenses, beam splitters and dichroic mirrors are used to guide and redirect light along the optical paths. The optoelectronic detection and acquisition system detects light arriving on the detector and captures it as timed single photon events, which are then transmitted to a computing system and stored for its post-processing and analysis. As one of the key factors to achieve the high time resolution, the optoelectronic detection and data acquisition subsystem is configured to detect and store time-tagged single photon arrival events, up to several millions per second. Detection can be performed by one or two detectors depending on the situation, and the correlation calculation may include auto-correlation and/or cross-correlation. The system may further include a spectroscopic system to allow the simultaneous measurement of the particle size distribution and other important chemical characteristics over time, through the coupling of one or more spectroscopic methods (e.g., Raman spectroscopy). Spectroscopy excitation and detection optical paths can be added to the optical system for this purpose and the post-processing software may include the acquisition, treatment, and visualization of all the simultaneously acquired data.

In an embodiment, as illustrated in FIG. 2, data containing the photon arrival times is transformed to intensity fluctuations, which may be arbitrarily binned, for visualization purposes. The user can then define a time window of interest, for instance as short as 20 ms. The time window defining the time resolution for the analysis may be selected as short as the rate of correlated events allows, which may be as low as 1 to 10 milliseconds. The correlation function (auto-correlation or cross-correlation) is calculated using the photon arrival times of the original data from the selected window. The correlation curve from the photon time tags may be computed in a single direct step by using a per se known correlation algorithm, for instance a correlation algorithm used in the field of fluorescence spectroscopy such as described in the scientific publication of Laurence et al, such algorithm however not being previously known for use in the field of particle size characterization. In the embodiment of FIG. 2, an advantageous feature derives from computing the correlation curve used to extract the particle size from the photon arrival times, in one direct step, without the need to go through the reconstruction of a binned intensity signal. Finally, the particle size distribution is calculated from the auto-correlation function, and the process is repeated for as many time windows as needed. Further analysis of the particle size distributions is then possible by running more complex statistical analysis.

In the embodiment illustrated in FIG. 2, the method may comprise the following steps:

In step S1, raw data containing photon arrival times output by the data acquisition module 24 are input and stored in a memory of the computing system 24 as:
1. Single vector for one detector
2. Two vectors, one for each detector
3. Single vector combining two detectors.

In the next step S2, the post-processing software in the computing system transforms photon arrival information to intensity values for visualization purposes.

In step S3 a time window of interest defined by the time range T (e.g. among time ranges from 10 ms to 100 ms) is selected or defined by the user or is provided as one of a plurality of predetermined range values stored in the computing system.

In the next step S4, t, u vectors from raw data holding photon time tags for time window T are extracted by the post processing software in the computing system, where f and u may come from the same (t=u) or different (t≠u) raw vectors, depending on the initial data loading.

In the next step S5 the correlation lag time binning module 26 of the post processing software computes vectors with lag time bin edges τ, from the desired binning parameters by employing an ordered binning strategy.

In the next step S6, the post processing software in the computing system computes and stores in the memory of the computing system the auto-correlation (t=u) or cross-correlation (t≠u) function values by using t, u and τ vectors in a per se known coincidence counting algorithm.

In the final step S7 the post processing software in the computing system computes particle size distributions from the previously calculated correlation function.

The above process may then be repeated one or more times for different time window ranges T, either on demand by the user, or in a predetermined manner stored in the computing system.

Further analysis of distributions such as using model fitting and statistics analysis may then be performed on the particle size distributions computed previously and optionally further comprising spectroscopic measurement data obtained from the spectroscopy system 4.

In FIG. 3 examples of the type of size distributions obtained with embodiments of the invention is shown. The dotted line shows the size distributions obtained for colloidal solutions of polystyrene particles with nominal values of 60 nm (panels a, b) and 220 nm (panels c, d), from a time window of 180 s. The size distribution of both 60 nm and 220 nm particles from a single 80 ms time window shows a narrower distribution and fluctuates during the experiment (panels a, c). It is also shown how the accumulation of size distributions from 80 ms windows during a period of 180 s resemble the distribution from a single 180 s window, for both 60 nm and 220 nm particles (panels b, d).

Referring to FIGS. 4 to 5, the step of computing and storing the correlation curve (step S6 in the general procedure illustrated in FIG. 2), may comprise a computation using a coincidence counting algorithm, as per se known for instance in Laurence et al., to compute the correlation function (in the form of cross-correlation or auto-correlation) from the photon arrival times, which is then used to extract the particle size distribution by fitting a physical model. The step of computing the autocorrelation by using the coincidence counting algorithm from literature is described just in FIGS. 4 and 5. FIG. 6 shows our binning strategy that is used to calculate the vector with lag time bin edges, one step before.

As depicted in FIG. 4, the algorithm needs three input vectors, the bin edges t, as well as t and u containing the photon arrival time tags, to calculate the correlation function. First, a vector containing the edges, or limits, of the lag time bins for which the auto-correlation function will be computed is defined. Then the vectors containing the photon arrival time information (time tags) are inputted, where both vectors should be equal if dealing with an auto-correlation, and different for a cross-correlation. The inner logic of the mentioned coincidence counting algorithm is described in the flow chart FIG. 5 describing the coincidence counting algorithm used to calculate the correlation function at discrete lag times.

Although in principle, the previously mentioned algorithm has the flexibility to compute the correlation function for an arbitrary sequence of lag time bins, the inventors have observed that the use of any arbitrary sequence was the origin of an artifact previously believed to be noise. The magnitude of this artifact in the correlation function is large enough to prevent the reconstruction of particle size distributions from very short time windows, where most of the information will be hidden under the artifact. This could as well hinder the ability to obtain correct particle size distributions for smaller particle sizes.

To solve this problem, an aspect of the invention is to implement a binning strategy that eliminates this artifact. FIG. 6 illustrates a graphic representation of the binning strategy according to an aspect of the invention, used to calculate the bin margins for the coincidence counting algorithm, and later used to calculate the correlation curve of photon arrival events. The correlation lag time is split in multiple bin groups with increasing width, as the lag time increases. Each consecutive group with index i is composed of n bins of width Wᵢ and half width Ci. The start and end margins of the bin series is defined as Aᵢ and Aᵢ₊₁ respectively The bin width increases for each group by a factor of m with respect to the previous one. The starting point of the first group A₁ must be equal to half of the base time resolution R, so that the first bin center matches R. It is considered that R should be equal, or an odd integer, of the acquisition time resolution used by the device to generate the time tags often referred as sync rate.

FIG. 7 shows the before and after of the binning strategy according to an aspect of the invention, by simulating the auto-correlation function of a perfect stream of photons, which theoretically should result in a constant value of 1. On the left (a) one can observe the auto-correlation with a prominent artifact after using logarithmically spaced bins, on the right (b) one can observe the auto-correlation function computed with this binning strategy, that matches the expected theoretical result. This means that, by using the above described coincidence counting algorithm upgraded with the lag time binning strategy according to an embodiment of the invention, one can achieve artifact-free, high quality correlation functions from a limited number of photons of milliseconds-long time windows.

Referring to FIGS. 8 and 9, a variant of the particle characterization system 2 according to the embodiment of FIG. 1 is illustrated. In this variant, the optical system 3 is configured to direct the light beam generated by the illumination system at an oblique angle through the sample system 1. The illumination system comprises a laser and the light beam generated by the illumination system is a collimated light beam. The collimated light beam (laser beam) Lin is directed through the microscope objective 10 at a position offset from the centre axis A of the microscope objective such that at the output of the microscope, the output light beam Lout is at an oblique angle β with respect to the centre axis A. The scattered light photons from the sample particles (the sample beam) passing back through the microscope objective 10 are captured by the optoelectronic detection system 5 as described previously in relation to the embodiment of FIG. 1.

The oblique angle β is in a range of 1° to 45°, preferably in a range of 3° to 35°, more preferably in a range of 5° to 30°.

In an embodiment with axial illumination, where the output light beam is centered on the optical axis A, reflection of the output light beam at the glass-liquid interface of the sample system reduces the signal-to-background ratio when signals are small due to the small size of certain particles 17 such as proteins. Axial illumination is not a problem for particles of 20 nm size or larger, however for very small particles it is advantageous to increase the signal to background ratio. Oblique illumination minimizes the reflection of the output light beam Lout at the sample system glass-liquid interface, and thus reduces background light transmitted back to the optoelectronic detection system 5. Therefore, the signal-to-background ratio improves significantly. The amplitude of the autocorrelation curve is higher for the oblique illumination than for axial illumination.

FIG. 10 shows autocorrelation curves of very small particles such as proteins, where it can be seen that with axial illumination, the signal-to-background ratio is too small for adequate measurement. The scattering signal becomes tiny while background due to the reflection remains the same. At the measured amplitude of autocorrelation of around ~0.002 it is not possible to extract reliable size distribution data. With oblique illumination, the signal-to-background ratio is sufficient to obtain reliable particle size distribution data. Although the scattering signal is small, the background is significantly reduced. At the measured amplitude of autocorrelation of around ~0.2 it is possible to extract reliable size distribution data with particle sizes of less than 20 nm, for instance protein sizes of 6 nm as illustrated in FIG. 11.

### Advantages

Compared to all the widely available commercial DLS systems for particle size characterization, the particle characterization system according to embodiments of the invention can perform:
Time-resolved in-situ particle size measurements.
Fast acquisition times, up to 10000 times faster than commercial solutions (milliseconds range).
Sub-ensemble screening of particle size constituents.
Characterization of ensemble particle size distributions, based on sub-ensemble screening statistics.
Possibility of simultaneous particle size and optical spectroscopy measurements.
All the above, from a localized region of interest (1 μm³ micron detection volume).
Low sample volume needed for measurements (microliters range).

Compared to the existent micro-DLS designs (already described in literature), the particle characterization system according to embodiments of the invention:
Includes an optoelectronic detection and acquisition system that can acquire time tagged single photon arrival events, where the dense information is key to compute high quality correlation functions in the post processing stage,
Improves its measuring capabilities by incorporating a flexible post-processing methodology for the calculation of particle size distributions from arbitrary time windows of the acquired data. This allows the user to perform time resolved DLS measurements on a microscope, to obtain the time evolution of particle size distributions with high time resolutions (as high as 20 ms). The user can then not only choose a specific time region from the DLS measurement, but an arbitrary combination of time windows as part of a more complex analysis (e.g., particle size evolution, sub-ensemble and ensemble statistics).
Allows the simultaneous confocal time-resolved measurement of particle size distributions, together with one or multiple spectroscopic methods (e.g., Raman spectroscopy). This boosts the ability of the system to capture complex sample information during in-situ measurements.

### Industrial Applications for Time-Resolved Particle Size Characterization

### Food Industry

In the food industry, DLS is used to characterize the particle size in solutions, suspensions and emulsions. Depending on the case, particles can for example be made of proteins, lipids and polysaccharides. The particle size distribution has a big impact in the flavor and texture of food products, as well as on the overall perception of quality and shelf life. The measurement of particle sizes with time-resolved DLS can be useful to evaluate the product stability in the following cases:
Monitor protein aggregation in dairy products (milk, cheese, etc.)
Follow the size stability of droplets in emulsions (salad dressings, mayonnaise, etc.)
Monitor changes in size of yeast cells in beverages (wine, beer, etc.)

### Pharma and Biotech

In the pharma and biotech industry, particle size is critical to guarantee the desired properties concerning product performance, processability, stability and bulk properties. As these properties are time-dependent, time-resolved DLS can be useful in the following cases:
Quality control of the particle size at different stages, from development to high-level production, in-situ or as a PAT (process analytical technology) device.
Study the aggregation process of pharmaceutical drugs, affecting the final function.
Follow protein aggregation over time.

### Publications about the Micro-DLS Optical Design

1. T. Hiroi, M. Shibayama, Dynamic light scattering microscope: Accessing opaque samples with high spatial resolution. Opt. Express 21, 20260 (2013)
2. T. Hiroi, M. Shibayama, Measurement of Particle Size Distribution in Turbid Solutions by Dynamic Light Scattering Microscopy. JoVE, 54885 (2017).
3. P. D. Kaplan, V. Trappe, D. A. Weitz, Light-scattering microscope. Appl. Opt. 38, 4151 (1999).
4. X.-L. Qiu, P. Tong, B. J. Ackerson, Proposal and testing of dual-beam dynamic light scattering for two-particle microrheology. Appl. Opt. 43, 3382 (2004).
5. J.-C. Wang, Design and testing of a novel microscopic photon correlation spectrometer with higher accuracy. J. Opt. A: Pure Appl. Opt. 3, 360-365 (2001).

### Publication on Data Post-Processing and Time-Resolved DLS

6. François. Liénard, Éric. Freyssingeas, Pierre. Borgnat, A multiscale time-Laplace method to extract relaxation times from non-stationary dynamic light scattering signals. J. Chem. Phys. 156, 224901 (2022).
7. T. Hiroi, S. Samitsu, K. Ishioka, Post-processing noise reduction via all-photon recording in dynamic light scattering. Science and Technology of Advanced Materials: Methods 1, 134-142 (2021).
8. A. V. Malm, J. C. W. Corbett, Improved Dynamic Light Scattering using an adaptive and statistically driven time resolved treatment of correlation data. Sci Rep 9, 13519 (2019).

### Publication on Algorithm to Calculate Correlation Function

9. T. A. Laurence, S. Fore, and T. Huser, “Fast, flexible algorithm for calculating photon correlations,” Opt. Lett., vol. 31, no. 6, p. 829, Mar. 2006, doi: 10.1364/OL.31.000829.

### RELATED PATENTS

1. Dynamic light scattering measurement device, dynamic light scattering measurement and analysis method, and measurement and analysis program (JP2022077588A)
2. Dynamic light scattering particle diameter distribution measuring system (JP2001074637A, JP3689274B2)
3. A particle diameter real-time supervision device for wet chemistry preparation (CN207689320U)
4. Photon detection device, photon detection method, fluorescence correlation spectroscopy device, fluorescence cross-correlation spectroscopy device, dynamic light scattering device, and fluorescence microscope (WO2017082218A1)
5. A simultaneous detection apparatus of raman and light scattering (KR100817854B1, KR20080025845A)
6. Procédé et système de détection rapide de particules sur la base d'une analyse d'ensemble d'échantillons par diffusion de lumière dynamique (WO2018129775A1)

### List of References Used

Sample system 1
   Sample stage 11
   Sample container 13
   Liquid medium 15
   Particles 17
Particle characterization system 2
   Optical system 3
      Illumination system 8
         Laser source
      Microscope objective 10
      Light focusing device 12
         Tube lens
         Pinhole
         Relay lens
      Bandpass filter 14
      Dichroic Mirror/Beam splitter 16, 16a, 16b
   Spectroscopy system 4
      Spectroscopy excitation device 18
      Spectroscopy detection device 20
      Beam splitter/Dichroic Mirror 16, 16c, 16d
   Optoelectronic detection system 5
      Photon detector 22
      Data acquisition module 24
   Computing system 6
      Post-processing software
         Correlation lag time binning module 26

1. A particle characterization system for measuring at least the size of particles in a liquid or colloidal medium, comprising an optical system, an optoelectronic detection system, and a computing system, the optical system comprising an illumination system configured to generate a light beam to illuminate the particles, a microscope objective configured to guide the light beam to the particles and collect the scattered light from the particles, a light focusing device configured to focus the scattered light from the sample to the optoelectronic detection system, the optoelectronic detection system comprising a photon detector and a data acquisition module connected to the photon detector, the optoelectronic detection system configured to time tag photons detected by the photon detector and to transmit the time tagged photon data to the computing system, the computing system comprising post-processing software configured to compute particle size distributions using an auto-correlation or cross-correlation computation on a bin group retained in a time window of a selected duration, said bin group formed of a plurality of bins of said time-tagged photon data, the post-processing software configured to perform a plurality of particle size distribution computations based on different time windows of different durations.

2. The particle characterization system of claim 1 wherein the illumination system comprises a laser device configured to generate a laser beam for illumination of the particles.

3. The particle characterization system of claim 1 further comprising a bandpass filter arranged in the illumination path configured to filter the wavelength of scattered light received from the sample configured to allow light wavelength of the laser to pass therethrough to the optoelectronic detection system.

4. The particle characterization system of claim 1 further comprising a spectroscopy system including a spectroscopy excitation device configured to generate a spectroscopy excitation beam projected through the microscope objective to the particles of the sample, and a spectroscopy detection device configured to receive the spectroscopy excitation beam returned from the particles back through the microscope objective and the light focusing device.

5. The particle characterization system of claim 4 wherein the spectroscopy system comprises a first dichroic mirror for reflecting the spectroscopy excitation beam through the microscope objective, and a second dichroic mirror for reflecting the return beam to the spectroscopy detection device

6. The particle characterization system of claim 4 wherein the spectroscopy excitation device and spectroscopy detection device are configured for Raman spectroscopy.

7. The particle characterization system of claim 1 wherein the optoelectronic detection system comprises at least a second photon detector receiving the returned particle scattered light via a beam splitter.

8. The particle characterization system of claim 1 wherein the post-processing software of the computing system comprises a correlation lag time binning module configured to generate bins of successively increasing durations to form at least one said bin group (G, G1, . . . Gi).

9. The particle characterization system of claim 8 wherein the bins have a duration of a constant A plus a variable W (A+W), the successive bin durations having a duration corresponding to the constant A plus an integer multiple n of the variable W (A+nW).

10. The particle characterization system of claim 8 wherein the correlation lag time binning module is configured to generate a plurality of bin groups (G, G1, . . . Gi), whereby the bin durations of different bin groups (G, G1, . . . Gi) have different variables W, W1, . . . Wi.

11. The particle characterization system of claim 1 wherein the optical system is configured to direct the light beam generated by the illumination system at an oblique angle (β) through the sample system relative to an optical centre axis of the microscope objective.

12. The particle characterization system of claim 11 wherein the oblique angle is in a range of 1° to 45°, preferably in a range of 3° to 35°, more preferably in a range of 5° to 30°.

13. A particle characterization system for measuring at least the size of particles in a liquid or colloidal medium, comprising an optical system, an optoelectronic detection system, and a computing system, the optical system comprising an illumination system configured to generate a light beam to illuminate the particles, a microscope objective configured to guide the light beam to the particles and collect the scattered light from the particles, a light focusing device configured to focus the scattered light from the sample to the optoelectronic detection system, the optoelectronic detection system comprising a photon detector and a data acquisition module connected to the photon detector, the optoelectronic detection system configured to time tag photons detected by the photon detector and to transmit the time tagged photon data to the computing system, the computing system comprising post-processing software configured to compute particle size distributions using an auto-correlation or cross-correlation computation on a bin group (G, G1, . . . Gi) retained in a time window of a selected duration, characterized in that the post-processing software of the computing system comprises a correlation lag time binning module configured to create lag time bins of successively increasing durations to form at least one said bin group (G, G1, . . . Gi).

14. The particle characterization system of claim 13 wherein the bins have a duration of a constant A plus a variable W (A+W), the successive bin durations having a duration corresponding to the constant A plus an integer multiple n of the variable W (A+nW).

15. The particle characterization system of claim 13 wherein the correlation lag time binning module is configured to generate a plurality of bin groups (G, G1, . . . Gi), whereby the bin durations of different bin groups (G, G1, . . . Gi) have different variables W, W1, . . . Wi.

16. The particle characterization system of claim 13 wherein the post-processing software is configured to perform a plurality of particle size distribution computations based on different time windows of different durations.

17. The particle characterization system of claim 16 wherein the illumination system comprises a laser device configured to generate a laser beam for illumination of the particles.

18. The particle characterization system of claim 17 further comprising a bandpass filter arranged in the illumination path configured to filter the wavelength of scattered light received from the sample configured to allow light wavelength of the laser to pass therethrough to the optoelectronic detection system.

19. The particle characterization system of claim 13 further comprising a spectroscopy system including a spectroscopy excitation device configured to generate a spectroscopy excitation beam projected through the microscope objective to the particles of the sample, and a spectroscopy detection device configured to receive the spectroscopy excitation beam returned from the particles back through the microscope objective and the light focusing device.

20. The particle characterization system of claim 19 wherein the spectroscopy system comprises a first dichroic mirror for reflecting the spectroscopy excitation beam through the microscope objective, and a second dichroic mirror for reflecting the return beam to the spectroscopy detection device

21. The particle characterization system of claim 19 wherein the spectroscopy excitation device and spectroscopy detection device are configured for Raman spectroscopy.

22. The particle characterization system of claim 13 wherein the optoelectronic detection system comprises at least a second photon detector receiving the returned particle scattered light via a beam splitter.

23. The particle characterization system of claim 13 wherein the optical system is configured to direct the light beam generated by the illumination system at an oblique angle (β) through the sample system relative to an optical centre axis of the microscope objective.

24. The particle characterization system of claim 23 wherein the oblique angle is in a range of 1° to 45°, preferably in a range of 3° to 35°, more preferably in a range of 5°to 30°.
